(19) United States
(12) Patent Application Publication
(10) Pub. No.: US 2011/0048971 A1
(43) Pub. Date: Mar. 3, 2011

(54) ROBUST POTENTIOMETRIC SENSOR

(76) Inventors: Michael M. Bower, Wareham, MA (US); David G. Fournier, Fall River, MA (US); Zhisheng Sun, Hopkinton, MA (US); Stephen B. Talutis, Milton, MA (US); Daniel G. Tower, Wrentham, MA (US); Steven J. West, Hull, MA (US)

(21) Appl. No.: 12/869,252

(22) Filed: Aug. 26, 2010

Related U.S. Application Data
(60) Provisional application No. 61/239,274, filed on Sep. 2, 2009.

(51) Int. Cl. G01N 27/30; G01N 27/333; G01N 27/26; B23P 11/00

(52) U.S. Cl. 205/787.5; 204/435; 204/416; 205/775; 29/428

(57) ABSTRACT

A modular potentiometric sensor includes a housing having measuring and reference half-cells, a temperature sensor, and solution ground combination assembly. An electrical conductor of the combination assembly extends through the housing, while remaining electrically isolated from the housing and half-cells, terminating at an electrically and thermally conductive end cap. Seals at opposite ends of the housing permit portions of the half-cells and the combination assembly to extend therethrough. The seals, measuring half-cell, and the combination assembly define an electrolyte compartment for the reference half-cell. The end cap provides close thermal coupling to the test fluid while also serving as a test fluid ground that is electrically isolated from the electrolyte compartment. The housing, measuring half-cell, reference half-cell, and combination assembly are modular, with the measurement sensor configurable in a plurality of lengths by altering the length of the housing independently of the half-cells and combination assembly.

### RELATED APPLICATION

This application claims the benefit of U.S. Provisional Patent Application Ser. No. 61/239,274, entitled Robust pH Sensor, filed on Sep. 2, 2009, the contents of which are incorporated herein by reference in their entirety for all purposes.

### BACKGROUND OF THE INVENTION

(1) Field of the Invention

The present invention generally relates to electrochemical sensors and more particularly to sensor assemblies including both sensing and reference half-cells in a single robust configuration.

(2) Background Information

Electrochemical potential measurements are commonly used to determine solution pH, other selective ion activities, ratios of oxidation and reduction activities, as well as other solution characteristics. A pH/ion selective electrode/oxidation reduction potential meter (hereafter referred to as a pH/ISE/ORP meter) is typically a modified voltmeter that measures the electrochemical potential between a reference half-cell (of known potential) and a measuring half-cell. These half-cells, in combination, form a cell, the electromotive force (emf) of which is equal to the algebraic sum of the potentials of the two half-cells. The meter is used to measure the total voltage across the two half-cells. The potential of the measuring half-cell is then determined by subtracting the known potential of the reference half-cell from the total voltage value.

The measuring half-cell typically includes an ion selective material such as glass. The potential across the ion selective material is well known by those of ordinary skill in the art to vary in a manner that may generally be described by the Nernst Equation, which expresses the electrochemical potential as a logarithmic function of ion activity (thermodynamically corrected concentration). A pH meter is one example of a pH/ISE/ORP meter wherein the activity of hydrogen ions is measured. pH is defined as the negative logarithm of the hydrogen ion activity and is typically proportional to the measured electrochemical potential.

FIG. 1 is a schematic of a typical, prior art arrangement 21 for measuring electrochemical potential. Arrangement 21 typically includes a measuring half-cell 30 and a reference half-cell 40 immersed in a process solution 6 and connected to an electrometer 50 by connectors 38 and 48, respectively. Measuring half-cell 30 and reference half-cell 40 are often referred to commercially (as well as in the vernacular) as measuring electrodes and reference electrodes, respectively. Electrometer 50 functions similarly to a standard voltage meter in that it measures a D.C. voltage (electrochemical potential) between measuring half-cell 30 and reference half-cell 40. Measuring half-cell 30 typically includes a half-cell electrode 36 immersed in a half-cell electrolyte 32, which is typically a standard solution (e.g., in pH measurements). For some applications, such as pH measurement, measuring half-cell 30 also includes an ion selective material 34. Alternatively, when measuring ORP (oxidation-reduction potential) the half-cell electrode 36 is immersed directly into the process solution 6.

The purpose of the reference half-cell 40 is generally to provide a stable, constant (known) potential against which the measuring half-cell may be compared. Reference half-cell 40 typically includes a half-cell electrode 46 immersed in a half-cell electrolyte 42 (FIG. 1). As used herein, the term “half-cell electrode” refers to the solid-phase, electron-conducting material in contact with the half-cell electrolyte, at which contact the oxidation-reduction reaction occurs that establishes an electrochemical potential. Half-cell electrolyte 42 (FIG. 1) is hereafter referred to as a reference electrolyte. Electrochemical contact between the reference electrolyte 42 (FIG. 1) and the process solution is typically established through a reference junction 44, which often includes a porous ceramic plug or the like, for achieving restricted fluid contact. Ideally, the reference junction 44 is sufficiently porous to allow a low resistance contact (which is important for accurate potential measurement) but not so porous that the solutions become mutually contaminated.

12-mm diameter glass membrane pH sensors are a standard configuration in process and laboratory analytical environments. Over years, users have looked for more and more features in this relatively small envelope. In addition to housing both the sensing and reference half-cells of the electrochemical measuring system as an integrated “combination” probe, incorporation of additional features may be desired. Furthermore—and especially for process analytical applications—the sensor is often required to operate in harsh chemical environments over a wide range of temperatures and pressures and in the presence of shock, vibration, electrical currents in the test fluid, and electromagnetic radiation. Compromises in functionality and performance have been made in order to meet these requirements and/or to conform to specific form factors such as the 12-mm diameter form factor.

As one example of such a compromise, the Ceragel CPS71 series of 12-mm pH probes commercially available from Endress+Hauser of Switzerland, does not provide a fluid/solution ground contact. The user is required to run a separate ground wire from the process fluid near the deployment location of the sensor back to the measuring instrument.

An example of a conventional combination glass pH electrode may be found in U.S. Pat. No. 7,176,692 to Adami, et al. As shown in FIG. 2, Adami, et al. discloses an outer glass tube 10, inner glass stem 8, liquid junction 24, pH glass membrane 16, electrolytes 18 and 28, and seal plugs 22 and 32.

Adami, et al. directly fuse the outer glass tube 10 to the inner stem 8. This approach is typical of many conventional combination probes, and tends to be relatively expensive while restricting the ability to modify the configuration for alternate sizes. Adami, et al., address a drawback of the aforementioned Ceragel CPS71 device by incorporating a fluid ground contact into their assembly in the form of a metal coating 14 applied to the outside surface of the glass. This approach, however, is generally incompatible with applications requiring the use of non-metallic components.

U.S. Pat. No. 3,666,651 to Makabe discloses a thermosensitive resistance element, i.e., a temperature sensor, inside the glass envelope of a pH half-cell. A drawback of this approach, however, is that the time response of the temperature sensor to changes in process fluid temperature tends to be compromised by the thermal mass of the combination pH probe.

US Patent Publication No. 2008/0283399 to Feng and Benson discloses a configuration in which a temperature sensor and solution ground contact are disposed within the reference electrolyte compartment. This approach tends to suffer the same drawback as Makabe with regard to the response time of the temperature sensor. In addition, placement of the solution ground contact in the electrolyte tends to be limiting.

Therefore, there exists a need for an improved potentiometric sensor for use in pH, selective ion activity, oxidation-reduction potential (ORP), and other electrochemical potential measurements that addresses the aforementioned drawbacks.

### SUMMARY

In accordance with one aspect of the invention, a modular electrochemical potential measurement sensor includes a housing having a transverse cross-sectional geometry sized and shaped for compatibility with industry standard mounting and insertion hardware. A measuring half-cell having a sensing element, and a reference half-cell, are both disposed within the housing. The reference half-cell includes a reference electrode, a reference electrolyte in electrolytic contact with the reference electrode, and a reference junction including an ion barrier configured to provide controlled flow of the reference electrolyte therein to form an electrical pathway extending through the reference junction. A temperature sensor and solution ground combination assembly is also disposed within the housing. The combination assembly includes an electrical conductor extending through the housing, while remaining electrically isolated from each of the housing, reference half-cell, and measuring half-cell, and terminating at an electrically and thermally conductive end cap. Resilient seals are disposed at proximal and distal ends of the housing, through which portions of the reference half-cell, the measuring half-cell, and the combination assembly extend. The seals in combination with the housing, the measuring half-cell and the combination assembly define an electrolyte compartment for the reference half-cell. The sensing element, porous member, and end cap extending through the seal, enable direct contact with a test fluid, wherein the end cap provides close thermal coupling to the test fluid while also serving as a test fluid ground that is electrically isolated from the electrolyte compartment. One or more of he housing, measuring half-cell, reference half-cell, and combination assembly are modular components, so that the measurement sensor may be fabricated in a plurality of lengths by altering the length of the housing independently of the measuring half-cell, reference half-cell, and combination assembly.

In another aspect of the invention, a method for measuring electrochemical potential includes providing the modular electrochemical potential measurement sensor of the foregoing aspect, inserting the sensor into a liquid, and electrically connecting the sensor to a meter. The method also includes using the meter to capture a total voltage value across the measuring half-cell and the reference half-cell, and subtracting the potential of the reference half-cell from the total voltage value.

In still another aspect of the invention, a method of fabricating a modular electrochemical potential measurement sensor includes providing a housing sized and shaped for compatibility with industry standard mounting and insertion hardware, placing a measuring half-cell having a sensing element, and a reference half-cell, within the housing. The reference half-cell includes a reference electrode, a reference electrolyte disposed in electrolytic contact with the reference electrode, and a reference junction including an ion bather configured to provide controlled flow of the reference electrolyte therein to form an electrical pathway extending through the reference junction. A temperature sensor and solution ground combination assembly are placed within the housing. The combination assembly is configured to have an electrical conductor extending through the housing, while remaining electrically isolated from each of the housing, reference half-cell, and measuring half-cell, and terminating at an electrically and thermally conductive end cap. Resilient seals are placed at proximal and distal ends of the housing, and portions of the reference half-cell, the measuring half-cell, and the combination assembly are extended therethrough, so that the seals in combination with the housing, the measuring half-cell and the combination assembly, define an electrolyte compartment for the reference half-cell. The sensing element, porous member, and end cap, are extended through the seal disposed at the distal end of the housing, to enable direct contact with a test fluid, so that the end cap provides close thermal coupling to the test fluid while also serving as a test fluid ground that is electrically isolated from the electrolyte compartment. One or more of the housing, measuring half-cell, reference half-cell, and combination assembly, are configured as modular components, so that the measurement sensor may be fabricated in a plurality of lengths by altering the length of the housing independently of the measuring half-cell, reference half-cell, and combination assembly.

### BRIEF DESCRIPTION OF THE DRAWINGS

FIG. 1 is a schematic representation of a typical electrochemical potential measurement system of the prior art;

FIG. 2 is a schematic representation of a sensor assembly of the prior art;

FIG. 3 is a schematic representation of sensor assembly embodying aspects of the present invention;

FIGS. 4-8 are schematic, not-to-scale representations of various optional aspects usable with the embodiment of FIG. 3; and

FIGS. 9-14 include graphical representations of test results of embodiments of the present invention.

### DETAILED DESCRIPTION

Embodiments of the present invention include a modular potentiometric sensor which combines various features in a single unified form factor, to address various drawbacks associated with the prior art. Briefly described, these features include a 12-mm diameter for compatibility with industry standard mounting and insertion hardware, glass or rugged plastic outer body, sensing half-cell(s) of various types (e.g., ion sensing half-cell for pH with spherical, domed, or flat glass membrane, ion-sensing half-cell for other ions, ORP half-cell of platinum or other inert metal), reference half-cell with ion barrier, and plastic or elastomeric seals which help define an electrolyte compartment while serving as primary structural elements.

Embodiments of the invention also facilitate the use of gelled electrolytes, and include a combination temperature sensor/solution ground assembly that provides close thermal coupling to a test fluid, while also providing a metallic or non-metallic solution ground contact that is electrically isolated from the internal electrolyte compartment. This ground contact may be used as a diagnostic test point or as an additional sensing half-cell. A porous liquid junction assembly serves as a fill-hole plug with high column strength. The assembly is steam-sterilizable, may include an internal pressure compensator, and its modularity enables convenient reconfiguration for different probe lengths.

Various embodiments of the present invention will be described in greater detail with specific reference to the accompanying Figures. For convenience of explication, these embodiments are described with respect to sensors having a measuring half-cell configured for the measurement of pH, since pH is a commonly measured analyte. However, it should be understood that other types of sensing half-cells, such as those used for ORP, fluoride ion detection, or other ion-selective measurements, may be substituted for, or added to, the described pH half-cell in order to create a sensor suitable for these other measurements. Moreover, although embodiments of the present invention are shown and described with respect to sensors of the 12-mm diameter form factor, it should be recognized that these embodiments may be configured with substantially any other form factor without departing from the scope of the present invention.

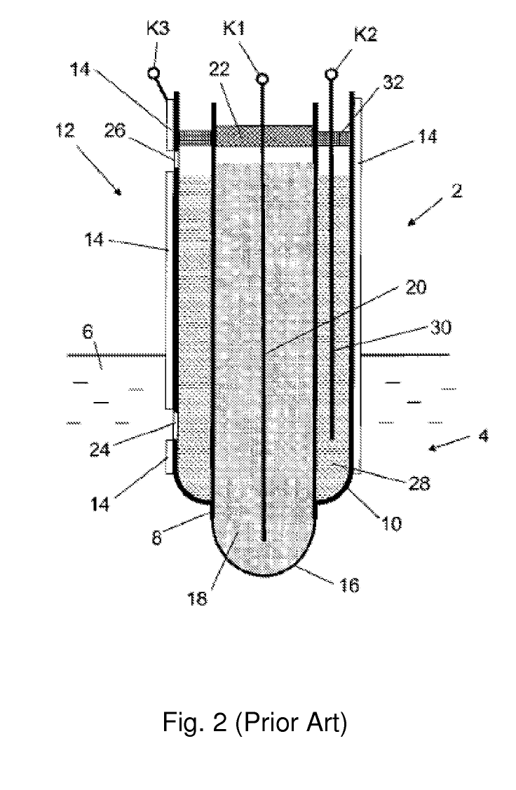

As mentioned above with respect to FIG. 2, because of their widespread use and acceptance, pH sensors/probes have often been fabricated from glass using various glassblowing techniques. As shown in FIG. 2, the pH-sensitive glass membrane 16 is typically fused to an inert glass tube or “stem” 8. A wire 20 and electrolyte 18 is then sealed into the stem to form the pH sensing half-cell. In order to combine with a reference half-cell, the pH half-cell is inserted and sealed into a second larger inert glass tube 10. The annulus thus formed serves as a compartment to house a reference electrolyte 28 and reference wire K2. The circuit between the pH and reference half-cells is completed by means of a liquid junction 24 between the reference electrolyte and test fluid 6. A common means of creating the liquid junction in such a glass electrode is to seal a piece of porous ceramic into the wall of the outer glass tube 10. The assembly described is referred to herein as a combination pH electrode or probe since it combines the sensing and reference half-cells in an integral unit.

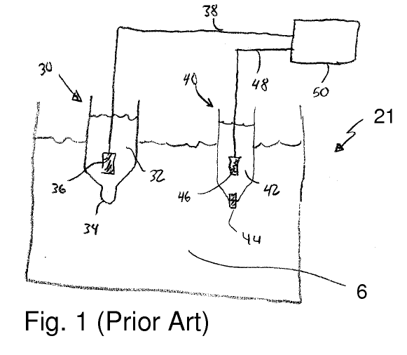

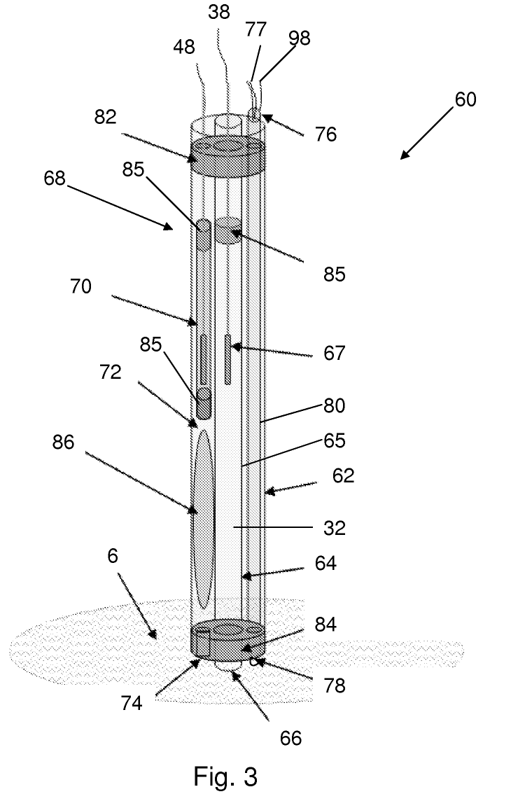

With reference to FIG. 3, various components of a representative embodiment of the present invention will be described in detail. As shown, a potentiometric (e.g., electrochemical) probe 60 is configured for pH measurement. For convenience, the means of connecting probe 60 (including leads 38 and 48 from the measuring and reference half-cells, and leads 77 and 98 from the temperature detection and solution ground) to a measuring apparatus (e.g., electrometer 50, FIG. 1) is not shown. Such connection may be accomplished by means of a conventional multiconductor cable, such as integrally built into the proximal end (e.g., the “top” of the assembly, in the orientation shown in FIG. 3) or with a multi-contact connector 92 (FIG. 5) which then interfaces with a cable. In particular embodiments, electrometer 50 takes the form of a conventional process variable transmitter (PVT) coupled to a factory automation network of the type sold by Invensys Systems, Inc., (Foxboro, Mass.) and which is configured to measure the electrochemical potential between the half-cells.

As shown, sensor 60 is a modular device including a housing 62 having a predetermined length and a predetermined diameter configured for compatibility with industry standard mounting and insertion hardware. As mentioned above, in particular embodiments the housing is provided with an industry standard diameter of 12 mm, and is fabricated from glass and/or plastic materials.

A measuring (e.g., pH) half-cell 64 extends longitudinally within housing 62, and includes a stem glass housing 65 which terminates at a sensing element 66 (e.g., a pH glass membrane) at the distal end thereof. Also, in the embodiment shown, measuring half-cell 64 includes a measuring electrode 67 disposed therein, in electrolytic contact (e.g., via a half-cell electrolyte 32) with membrane 66. Membrane 66 may take substantially any form factor, such as a spherical, domed, or flat configuration.

A reference half-cell 68 is also disposed within housing 62, and includes a reference electrode 70, a reference electrolyte 72 disposed in electrolytic contact with reference electrode 70, and a reference junction 74 including an ion barrier, e.g., in the form of a porous member configured to provide controlled flow of the reference electrolyte 72 therein to form a primary electrical pathway extending through the reference junction 74.

Reference junction 74 may take the form of a porous ceramic plug or the like (e.g., porous Teflon® (polytetrafluoroethylene, DuPont), porous KYNAR® (polyvinyldifluoride, Elf Atochem, N.A.), or wood) or nominally any other porous material) for achieving restricted fluid contact. Reference junction 74 is sufficiently porous to allow a low resistance contact (for accurate potential measurement) but not so porous that the solutions become excessively mutually contaminated. The skilled artisan will recognize that pore size, percent porosity, and effective cross-sectional area of the reference junction 74 must all be balanced, in conjunction with the particular electrolyte used, to achieve the desired restricted fluid contact. In particular exemplary embodiments, junction 74 may include a porous ceramic plug of the type conventionally used in the DolpHin™ sensor available from Invensys Systems, Inc., e.g., having an effective diameter of approximately 0.05 to 0.14 inches, pore sizes between about 0.2 to 0.3 μm, and total percent porosity of 20 to 30 volume percent.

As also shown, in particular embodiments, the reference electrode 70 is encased in a NAFION® (DuPont) tube 71. Those skilled in the art will recognize that NAFION® is a permselective polymer that prevents complex silver anions in the reference half-cell from entering the bulk electrolyte 72 where they may diffuse to the liquid junction 74 and cause clogging.

It should be recognized that any number of materials may be used for electrolytes 32 and 72. Some examples of reference electrolytes 72 include a solution including potassium chloride, silver chloride, and combinations thereof. One particular example includes a mixture of about 4 molar potassium chloride and saturated silver chloride. The reference electrode 70 may also be fabricated from any number of suitable materials, including, for example, silver, silver-silver chloride, mercury-mercurous sulfate, mercury-mercurous chloride, and other redox couples.

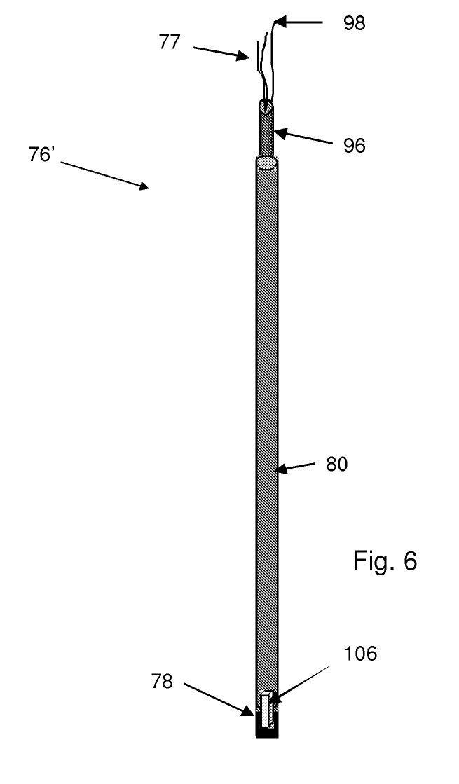

A temperature sensor/solution ground assembly 76 is disposed within housing 62, and includes an electrical conductor 98 extending through the housing, while remaining electrically isolated from the housing 62, from the reference half-cell 68, and from the measuring half-cell 64, and terminating at an electrically and thermally conductive metallic or non-metallic end cap 78 disposed at the distal end of the sensor 60. In the particular embodiment shown, this electrical isolation is provided by use of a tubular electrically non-conductive sleeve 80. Assembly 76 also includes electrical conductors 77 extending to a temperature detector (e.g., RTD 106, FIG. 6) disposed at the distal end of the housing, e.g., within end cap 78.

Seals 82 and 84, e.g., fabricated from plastic, elastomeric, or other suitable electrically non-conductive and chemically inert resilient materials, are disposed at proximal and distal ends of the housing, respectively. Examples of suitable materials include various elastomers such as silicone rubber, EPDM, fluoroelastomers such as VITON® (DuPont), and perfluoroelastomers such as Kalzrez™ or Chemraz™ may be chosen for their mechanical and chemical properties. Polymers such as PTFE, PFA, or PEEK may also be used, with or without elastomeric O-rings. Similar seals may be used in a conventional manner within the half-cells 64 and 68, such as shown at 85.

Proximal and distal portions of the reference half-cell 68, the measuring half-cell 64, and the temperature sensor assembly 76 extend through the seals 82, 84, as shown. The seals 82, 84, in combination with housing 62, measuring half-cell 64, and the temperature sensor assembly 76, effectively define an electrolyte compartment for the reference electrolyte 72. Optionally, the reference electrolyte 72 may take the form of a conventional gelled electrolyte. It should be recognized that gelled electrolytes tend to provide for relatively slow diffusion, which advantageously tends to slow electrolyte contamination during use.

It is noted that in the configuration shown, the conductive (optionally gelled) electrolyte 72 in the annular electrolyte compartment surrounds the high-impedance pH half-cell 64 to effectively shield it from electromagnetic radiation. Moreover, an optional internal pressure compensator 86 may be disposed within the reference electrolyte compartment. Compensator 86 is configured to expand or contract in response to relatively low or high external pressures on the housing 62, to help compensate for pressure variations in the test (process) fluid 6. In particular embodiments, pressure compensator 86 may take the form of a sealed, gas (e.g., air)-filled polymeric tube. The gas may thus compress when subjected to higher pressure from the process 6, or due to thermal expansion of the reference electrolyte 72. This compression should help guard against components rupturing or the seals 82, 84 or liquid junction 74 being blown out of the body 62. In this regard, it is noted that tube compression due to external process pressure generally has not been problematic with conventional glass electrodes due to the inherent rigidity of their glass housings. The pressure compensator 86 may, however, be desired in embodiment hereof, which employ plastic housings 62.

It should be recognized that in addition to use within the reference cell 68, a pressure compensator 86 may also be disposed within the measuring half cell 64. However, such use may be unnecessary in the event the measuring half-cell is a pH half cell or other half-cells fabricated from hermetically sealed glass, since such glass is relatively unaffected by the pressures and temperatures experienced in typical applications.

Thus as shown, membrane 66, porous member 74, and the end cap 78 extend through seal 84 disposed at the distal end of the housing 62, to enable direct contact with test fluid 6. In this configuration, end cap 78 provides close thermal coupling to test fluid 6, to facilitate temperature measurement. In addition, because the end cap 78 is electrically conductive, while also being electrically isolated (e.g., by sleeve 80) from the reference electrolyte 72, the cap 78 may serve as a test fluid ground which may be used as a diagnostic test point or as an ORP sensor, etc., as discussed in greater detail hereinbelow.

It should be recognized that the above-described construction of sensor 60, the housing 62, measuring half-cell 64, reference half-cell 68, and temperature sensor assembly 76 are each configured as modular components which are substantially independent of one another. This modular construction enables the measurement sensor 60 to be fabricated in a plurality of lengths simply by altering the length of the housing 62 independently of the measuring half-cell 64, reference half-cell 68, or temperature sensor/ground assembly 76. This length modification option will be described in greater detail hereinbelow with respect to FIG. 5.

The various components may be fabricated from steam-sterilizable materials, i.e., materials that maintain their structural and chemical integrity through repeated steam sterilizations and operation at elevated temperatures and pressures. The body 62, for example, may be fabricated from glass. However, while glass has advantages such as transparency, inertness, and low cost, it suffers from fragility, particular when fabricating sensors of relatively long length. Thus, particular embodiments may use a body fabricated from a relatively rugged plastic tube. Examples of suitable plastics may include any number of structurally rugged, chemically inert materials, such as PEEK (polyetheretherketone), Ryton® PPS (polyphenylene sulfide, Chevron Phillips Chemical Company), or Kynar® (PVDF). In various embodiments, these polymeric materials may provide the desired resistance to breakage, while also providing sufficient structural rigidity to protect relatively fragile interior components such as the stem glass 65, etc., from damage both during use and during installation and removal from the process 6.

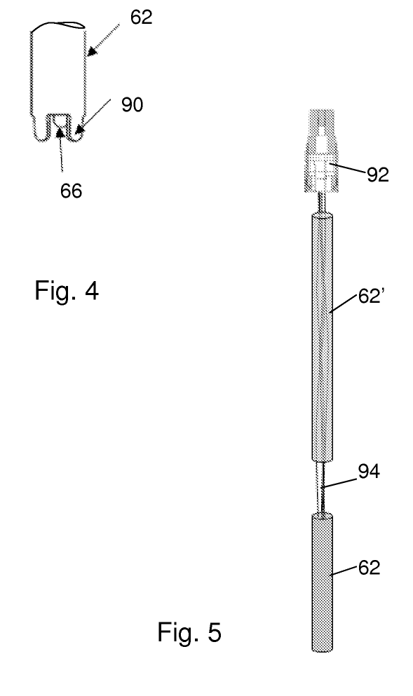

It will be noted that the above-described modular construction provides for enhanced flexibility of construction relative to conventional approaches. For example, a membrane 66 (e.g., a pH glass membrane) of substantially any desired configuration may be used, including spherical, domed, or flat membranes. An embodiment including a substantially flat membrane 66, positioned flush to the distal process seal 84, combined with a body 62 fabricated from PEEK, provides for an especially robust sensor. Also, unlike glass, a plastic such as PEEK is readily machined or molded. This allows, for example, incorporation of protective fluting 90 to further protect the glass membrane 66 against damage or breakage, such as shown in FIG. 4.

As mentioned above, the modular configuration described above provides for conveniently adapting the various embodiments of sensor 60 to different overall lengths. Not only do different applications require different process insertion depths, but mounting and insertion hardware for electrochemical (e.g., pH) sensors is becoming more and more standardized as well. Hardware for 12-mm diameter pH probes is commonly available that accommodates lengths of 120, 220, 360, and 425 mm However, in prior art approaches, such as described hereinabove with respect to FIG. 2, changing the overall length is relatively complex, generally requiring changing the lengths of many other components in addition to the outer housing, including the measuring half-cell, wiring and insulation for temperature sensors and other components, etc. Moreover, as also mentioned above, difficulties associated with glass housings tend to be greatly exacerbated when length is doubled or trebled.

In contrast, as mentioned above, the modularity of embodiments of the present invention enables probes to be conveniently provided in various sizes (e.g., lengths), without requiring all of the components to be resized. For example, turning now to FIG. 5, a plastic outer body 62 of a relatively short length (e.g., 120 mm), may be lengthened by adding a plastic body extender 62′ and running longer wire leads 94 to the proximal end (e.g., to connector 92). Such an embodiment may be sold as a kit including the shortest (e.g., 120 mm) housing 62, one or more extenders 62′, and internal wiring 94 (including leads 77, 98 and tubing 80) which is long enough for use with the extender(s) 62′. (The wiring 94 may be shortened by the user in the event the extender is not to be used.) The extender(s) 62′ may be connected to the shortest version by any suitable means, such as a bayonet or snap-fit connector, threaded connections, and/or glue, etc. Similarly, embodiments having a housing with a user-adjustable length may be provided. For example, a relatively long housing may be provided with transverse score lines spaced along its length to enable a user to conveniently cut or break the housing to a desired length. This flexibility to conveniently provide for variable lengths may provide significant advantages to a manufacturer in terms or product cost, inventory, and cycle time.

Turning now to FIG. 6, a particular embodiment of temperature sensor/solution ground assembly 76 is shown and described as assembly 76′. This particular embodiment includes an electrically conductive tube 96, e.g., of stainless steel or other metal, which provides electrical contact between the solution ground contact (e.g., end cap) 78 and ground wire lead 98 at the proximal end of the probe. The tube 96 is closed, e.g., by welding, at the distal end to preventingress of the process fluid. It is noted that in some applications, the tube 96 itself may serve as a satisfactory solution ground contact. However, metals—even stainless steels—are subject to corrosion in some process fluids. For this reason, particular embodiments employ an end cap 78 which is electrically conductive, but non-metallic, to serve as a solution ground contact. End cap 78 may be fabricated from any number of electrically conductive, non-metallic materials known to those skilled in the art. In particular embodiments, end cap 78 is fabricated from PVDF, due to its wide applicability to various applications and its general acceptance by users in the field of electrochemical sensing.

The solution (process fluid) ground contact, such as provided by end cap 78, may be used to provide a reference potential that may be subtracted from the potentials provided by sensing and reference half-cells 64 and 68, respectively (FIG. 3). Such use may effectively prevent variable, spurious currents and potentials in the process fluid 6 (FIG. 3) from interfering with the measured pH signal. In addition, as mentioned above, a solution ground contact 78 may enable useful diagnostics when the readout instrumentation (e.g., electrometer 50, FIG. 1) has such capabilities. For example, monitoring the electrical resistance between the ground contact 78 and the internal pH half-cell wire 38 (FIG. 3) may indicate a break or crack in the glass membrane 66 (FIG. 3). Likewise, monitoring the resistance of the liquid junction 74 may have diagnostic value. However, in order to make this measurement it is necessary to electrically insulate the ground contact 78 from the reference electrolyte 72 (FIG. 3). Therefore, in order to provide this functionality, the (stainless steel) tube 96 may be provided with insulating barrier 80 where tube 96 passes through the reference electrolyte 72 as shown in FIG. 3. As shown in FIG. 6, barrier 80 may take the form of conventional heat-shrinkable tubing. Other insulation schemes would occur to those versed in the art in light of the instant disclosure.

As mentioned briefly above, the ground contact 78 may also serve another purpose. If the solution-contacting end cap 78 is fabricated from an inert metal, such as platinum, it may serve as an ORP sensing half-cell. In such an embodiment, the 12-mm probe becomes a multi-measurement device capable of measuring pH and ORP simultaneously when connected to an appropriately configured electrometer 50 (FIG. 1).

Further, as discussed hereinabove, the solution ground assembly 76′ may serve as a housing for a temperature sensor 106 in the form of an RTD or other element, e.g., disposed within end cap 78, to thus serve as a combination solution ground and RTD assembly. As also discussed above, this configuration brings the RTD 106 relatively close to the process fluid 6 (FIG. 3), with separation provided by (e.g., end cap) materials with relatively good heat conducting properties. Moreover, the temperature sensor may be thermally isolated from the thermal mass of the probe by embedding it in the weakly heat-conducting process seal 84, while it is thermally coupled to the process fluid 6 by means of the thin-walled and relatively strongly heat-conducting end cap 78. This embodiment has been shown to achieve relatively rapid response to changes in process temperature, as discussed hereinbelow with respect to exemplary test results.

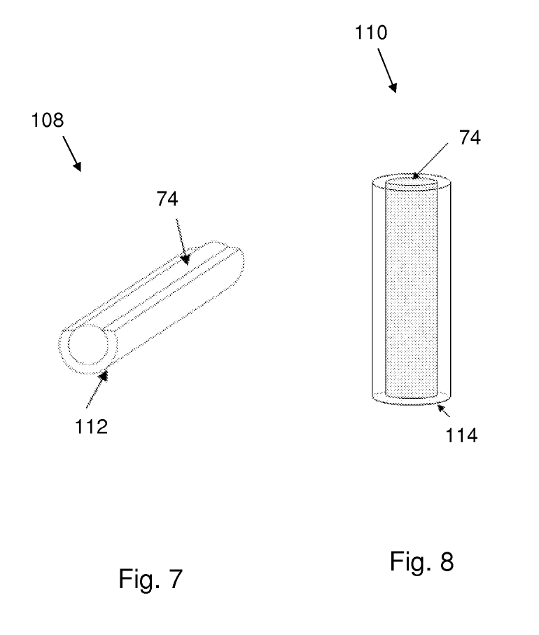

Turning now to FIGS. 7 and 8, particular embodiments of the present invention may benefit from liquid junction assemblies 108 or 110. As mentioned above, in many conventional pH products, a porous ceramic element is sealed directly into the glass body. This approach may be satisfactory for many applications. However, this approach generally requires glass working skill to manufacture, involves the possibility that fused glass may penetrate some of the pores causing blockage, and the inability of a user to replace the junction if clogged.

Embodiments of the present invention address these concerns by use of seal 84, into which the reference junction 74 may be press-fit. Moreover, the optional assemblies 108 and 110 facilitate this insertion while helping to avoid damage to the porous junction 74.

Referring in particular to FIG. 7, a relatively hard polymeric (plastic) sleeve 112 may be formed, e.g., by slicing a portion of a plastic tube lengthwise so that its inner diameter could be opened slightly. A porous rod 74 may then be slipped into the sleeve 112 with the inner diameter of the sleeve allowed to clamp over it in a press-fit manner as shown. The resulting assembly 108, although not a perfect cylinder, may be press-fit into a hole in elastomeric seal 84, which then conforms to the “half moon” shape of the assembly 108.

Alternatively, as shown in FIG. 8, a porous rod 74 may be encased in heat-shrinkable polymeric (e.g., PVDF) tubing/sleeve 114, or other tubing of suitable material, to form assembly 110. This assembly forms a substantially cylindrical cross-section, which enables it to be press fit into a seal 84. In this embodiment, seal 84 may be fabricated from a less resilient material than that used with assembly 108, since there are essentially no gaps around the assembly 110 which need to be filled by a resilient seal. Thus, while a seal 84 fabricated from an elastomeric material may be used, other materials, such as relatively hard plastic, may also be used in combination with this assembly 110.

These liquid junction sub-assemblies 108, 110, tend to enable simplified installation, which does not require any specialized skill. In addition, the porosity of the junction 74 is not compromised by fused glass. Moreover, prior to installation, the hole in the process seal 84 may be conveniently used for filling the electrolyte chamber with electrolyte 72. If the junction becomes clogged or coated during use, it may be conveniently replaced (e.g., with an appropriate tool, the old junction may be pulled out or pushed into the electrolyte compartment, or a replacement junction may be used to displace the old one). (The electrolyte 72 may also be replenished once the junction is removed, prior to replacement.) This approach may also accommodate the use of materials for junction 74, which may not be well suited for sealing to glass and/or for press fit installation, such as various porous ceramics or other porous media such as porous PTFE, since sealing into glass is not required and the plastic sleeve or shrink tubing, etc., provides the column strength necessary for a press fit.

The following illustrative examples are intended to demonstrate certain aspects of the present invention. It is to be understood that these examples should not be construed as limiting.

### EXAMPLES

### Example 1

### Robustness against Sterilization

An electrode 60 (FIG. 3) was fabricated with a domed pH glass membrane 66, a 12 mm diameter PEEK housing 62, Viton® seals 82, 84, a liquid junction assembly 114 including a ceramic rod within a PEEK sleeve, a Kynar® RTD/solution ground end cap 78, a PFA pressure equalization bladder 86, and a NAFION® ion-barrier inner reference assembly 70.

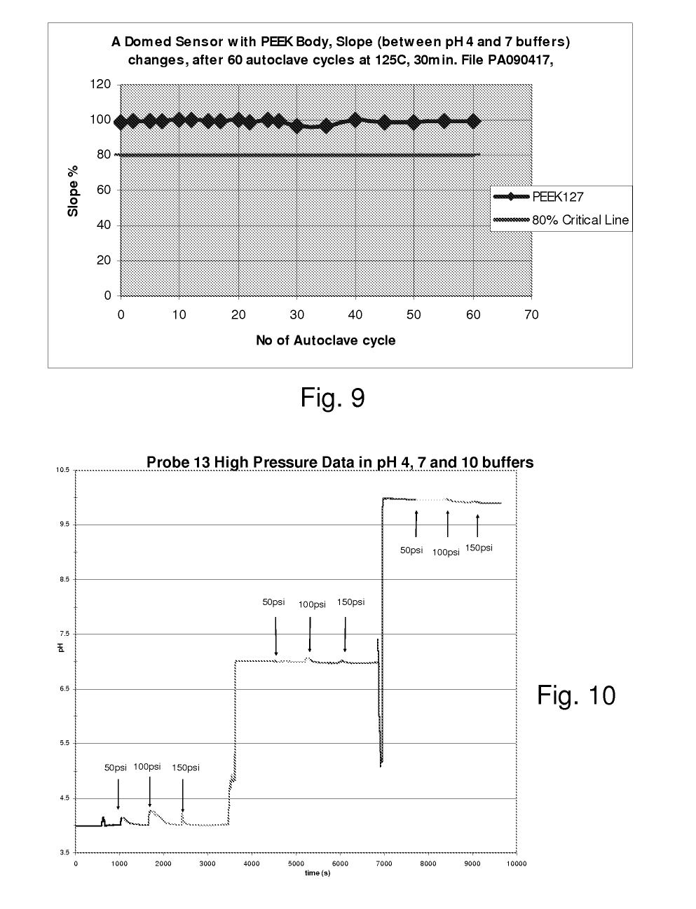

FIG. 9 shows the test results of the pH sensor of Example 1 after multiple 30-minute autoclave cycles (steam-sterilizations) at 125° C. Slope between pH 4 and 7 buffers remained above 90% of theoretical (Nernst) after 60 cycles. 80% slope was chosen as benchmark for acceptable performance.

### Example 2

### Operation at Process Pressure of 150 psi

An electrode 60 was fabricated substantially as in Example 1, but with the 12 mm diameter housing 62 fabricated from Pyrex® glass instead of PEEK.

FIG. 10 shows the response of the pH sensor of Example 2 in pH 4, 7, and 10 buffers under a process pressure of 150 psi. No physical damage nor abnormal response behavior was observed.

### Example 3

### Operation at elevated Temperature and Pressure

FIG. 11 shows the output of a probe configured as in Example 2 in pH 4 buffer at a temperature of 121° C. pressure of 150 psi. The output shown indicates successful operation.

### Example 4

### Operation in Partial Vacuum

An electrode 60 was fabricated substantially as in Example 2, but with a flat, instead of domed, pH glass membrane 66.

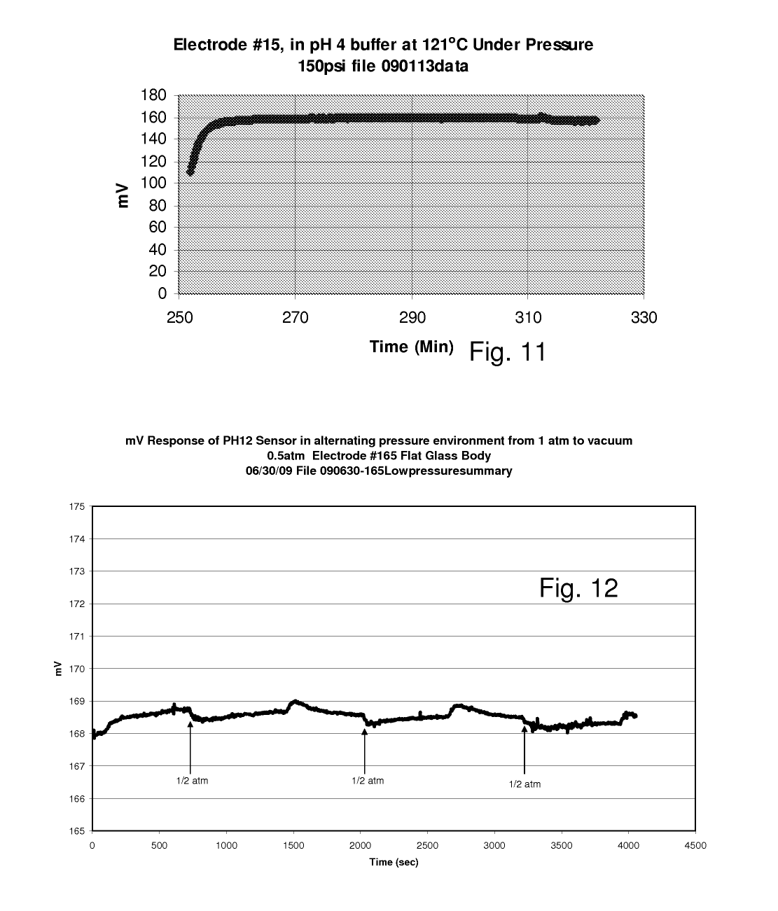

FIG. 12 shows the response of the sensor of this Example 4 in pH 4 buffer at a pressure alternating between 1.0 and 0.5 atm (101 and 50.5 kpa). Results showed an output change of less than 1 mV (representing less than 0.02 pH). These results indicate successful performance.

### Example 5

### Performance at Lowered Temperature

An electrode was fabricated substantially as in Example 1, but with a flat pH glass membrane 66, and with a Kynar® sleeve 114 in the liquid junction assembly.

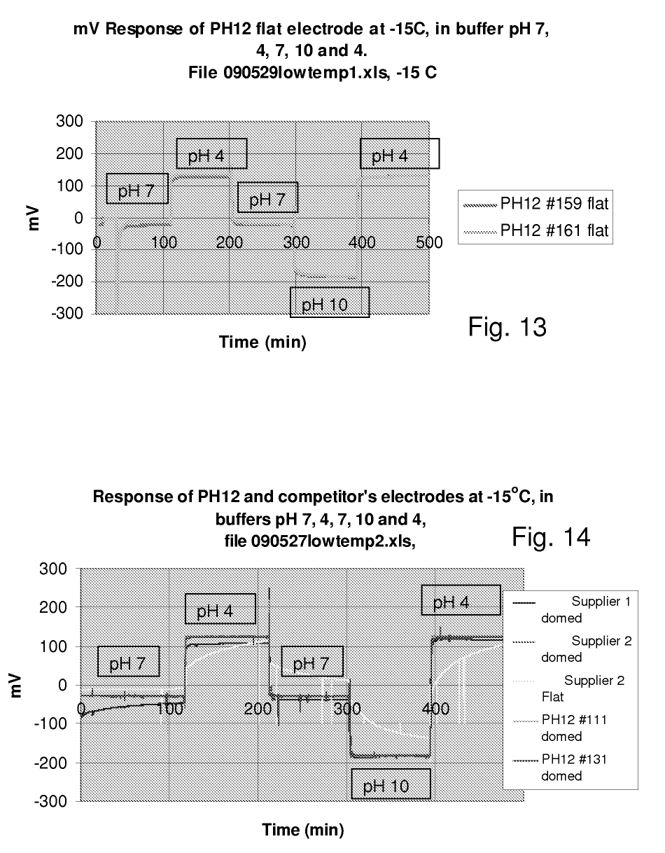

FIG. 13 shows the response of the sensor of this Example 5 in pH 7, 4, 7, 10, and 4 buffers, respectively, at a temperature of −15° C. These results indicate successful performance.

### Example 6

### Low-Temperature Performance Compared to Prior Art

FIG. 14 shows the response of the probes of Examples 1 and 2 compared to prior art probes at −15° C. Probes of present invention showed fast and stable response to pH 4, 7 and 10 buffers, reaching 90% response less than 1 minute, while prior art domed-membrane probes from Suppliers 1 and 2 showed 90% response in about 2 and 1.3 minutes, respectively, and with flat-membrane probe from Supplier 2, no stable response could be reached after 30 minutes.

### Example 7

### Thermal Shock

Probes with the features indicated in Table 1 were exposed to 100° C. boiling water for 5 minutes and then put into iced water for 5 minutes. The experiment was repeated 3 times and pH response performance was then tested at room temperature. No slope deterioration nor process seal nor liquid junction movement was observed.

TABLE 1

| | Membrane | Process | Junction | % Slope before | % Slope after | |
|---|---|---|---|---|---|---|
| Sensor | Type/Body | Seal | Sleeve | Thermal | Thermal | Seal/Junction |
| ID | Material | Material | Material | Shock | Shock | Movement |
| 1 | Domed/Glass | EPDM | PEEK | 97.97 | 99.66 | None |
| 2 | Domed/Glass | EPDM | PEEK | 97.97 | 99.10 | None |
| 3 | Domed/Glass | EPDM | PEEK | 98.28 | 99.10 | None |
| 4 | Domed/PEEK | EPDM | PEEK | 98.54 | 99.10 | None |
| 5 | Domed/PEEK | EPDM | PEEK | 98.54 | 100.23 | None |
| 6 | Domed/PEEK | EPDM | PEEK | 97.97 | 98.54 | None |
| 7 | Flat/PEEK | Viton ® | Kynar ® | 98.54 | 99.66 | None |
| 8 | Flat/PEEK | Viton ® | Kynar ® | 98.54 | 99.66 | None |
| 9 | Flat/PEEK | Viton ® | Kynar ® | 99.10 | 99.66 | None |

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

While several embodiments of the present invention have been shown and described with various characteristics, it should be understood that one or more of these characteristics of one embodiment may be substituted or added to characteristics of other embodiments without departing from the spirit and scope of the present invention.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A modular electrochemical potential measurement sensor comprising:
a housing having a transverse cross-sectional geometry sized and shaped for compatibility with industry standard mounting and insertion hardware;
a measuring half-cell disposed within the housing, having a sensing element;
a reference half-cell disposed within the housing, the reference half-cell including a reference electrode, a reference electrolyte disposed in electrolytic contact with the reference electrode, and a reference junction including an ion barrier configured to provide controlled flow of the reference electrolyte therein to form an electrical pathway extending through the reference junction;
a temperature sensor and solution ground combination assembly disposed within the housing;
the combination assembly including an electrical conductor extending through the housing, while remaining electrically isolated from each of the housing, reference half-cell, and measuring half-cell, and terminating at an electrically and thermally conductive end cap;
resilient seals disposed at proximal and distal ends of the housing, through which portions of the reference half-cell, the measuring half-cell, and the combination assembly extend;
the seals in combination with the housing, the measuring half-cell and the combination assembly defining an electrolyte compartment for the reference half-cell;
the sensing element, porous member, and end cap extending through the seal disposed at the distal end of the housing, to enable direct contact with a test fluid, wherein the end cap provides close thermal coupling to the test fluid while also serving as a test fluid ground that is electrically isolated from the electrolyte compartment;
at least one of the housing, measuring half-cell, reference half-cell, and combination assembly are configured as modular components, wherein the measurement sensor is configured for being fabricated in a plurality of lengths by altering the length of the housing independently of the measuring half-cell, reference half-cell, and combination assembly.

2. The sensor of 1 wherein said measuring half-cell comprises a pH electrode, and said sensing element includes pH-sensitive glass.

3. The sensor of claim 2, wherein the pH-sensitive glass has a configuration selected from the group consisting of spherical, domed, or flat.

4. The sensor of claim 3, wherein the reference junction comprises a porous member.

5. The sensor of claim 1, wherein the seals are fabricated from a plastic material.

6. The sensor of claim 5, wherein the seals are fabricated from an elastomeric material.

7. The sensor of claim 1, wherein the housing is fabricated from glass.

8. The sensor of claim 1, wherein the housing is fabricated from a polymeric material.

9. The sensor of claim 8, further comprising an internal pressure compensator disposed within the electrolyte compartment, the pressure compensator configured to respectively expand or contract in response to relatively low or high external pressures on the housing.

10. The sensor of claim 1, wherein the electrically and thermally conductive end cap is metallic.

11. The sensor of claim 10, wherein the end cap is fabricated from an inert metal.

12. The sensor of claim 11, wherein the combination assembly, including the end cap, forms an ORP half-cell.

13. The sensor of claim 12, configured for simultaneous measurement of two or more analytes.

14. The sensor of claim 13, wherein the two or more analytes comprise at least pH and ORP.

15. The sensor of claim 1, wherein the electrically and thermally conductive end cap is non-metallic.

16. The sensor of claim 1, being fabricated from steam-sterilizable materials.

17. The sensor of claim 1 wherein said porous member comprises a porous rod disposed within a polymeric sleeve.

18. The sensor of claim 17, wherein the polymeric sleeve extends less than or a full 360 degrees about the porous rod.

19. The sensor of claim 1, further comprising a gelled reference electrolyte disposed within the electrolyte compartment.

20. The sensor of claim 1 wherein said reference electrolyte comprises a mixture of about 4 molar potassium chloride and saturated silver chloride.

21. The sensor of claim 1 wherein said reference electrode comprises a member of the group consisting of silver, silver-silver chloride, mercury-mercurous sulfate, mercury-mercurous chloride, and other redox couples.

22. The sensor of claim 1 wherein said reference electrolyte comprises a member of the group consisting of potassium chloride, silver chloride, mixtures of silver chloride and potassium chloride, and combinations thereof.

23. The sensor of claim 1 wherein said measuring half-cell, said reference half-cell, and said temperature sensor assembly are configured for being coupled to a process variable transmitter.

24. The sensor of claim 1 wherein said measuring half-cell comprises an ion selective electrode.

25. The sensor of claim 24 wherein said ion selective electrode comprises a fluoride ion selective electrode.

26. The sensor of claim 1 wherein said measuring half-cell comprises an oxidation-reduction potential (ORP) electrode.

27. The sensor of claim 1, wherein the electrolyte compartment extends substantially 360 degrees about the measuring half-cell.

28. The sensor of claim 1, comprising a temperature detector disposed within the end cap.

29. The sensor of claim 1, comprising a housing extension configured for being coupled to a proximal end of the housing to extend the length of the sensor without requiring lengthening of the measuring half-cell.

30. A modular electrochemical potential measurement sensor kit comprising the modular electrochemical potential measurement sensor of claim 1, and a housing extension configured for being coupled to a proximal end of the housing to enable a user to extend the length of the sensor without requiring lengthening of the measuring half-cell, by coupling the housing extension to the housing.

31. A method for measuring electrochemical potential comprising:
(a) providing the modular electrochemical potential measurement sensor of claim 1;
(b) inserting the sensor into a liquid;
(c) electrically connecting the sensor to a meter;
(d) using the meter to capture a total voltage value across the measuring half-cell and the reference half-cell; and
(f) subtracting the potential of the reference half-cell from the total voltage value.

32. The method of claim 31, further comprising capturing a ground potential using the end cap, and subtracting the ground potential from the potentials provided by the sensing and reference half-cells.

33. The method of claim 32, comprising monitoring electrical resistance between the end cap and the measuring electrode, and between the end cap and the reference electrode.

34. The method of claim 32, comprising simultaneously measuring two or more analytes.

35. The method of claim 34, comprising using the end cap to form an ORP half-cell.

36. The method of claim 35, comprising simultaneously measuring ORP and pH.

37. A method of fabricating a modular electrochemical potential measurement sensor comprising:
(a) providing a housing sized and shaped for compatibility with industry standard mounting and insertion hardware;
(b) disposing a measuring half-cell within the housing, the measuring half-cell having a sensing element;
(c) disposing a reference half-cell within the housing, the reference half-cell including a reference electrode, a reference electrolyte disposed in electrolytic contact with the reference electrode, and a reference junction including an ion barrier configured to provide controlled flow of the reference electrolyte therein to form an electrical pathway extending through the reference junction;
(d) disposing a temperature sensor and solution ground combination assembly within the housing;
(e) configuring the combination assembly with an electrical conductor extending through the housing, while remaining electrically isolated from each of the housing, reference half-cell, and measuring half-cell, and terminating at an electrically and thermally conductive end cap;
(f) disposing resilient seals at proximal and distal ends of the housing, and extending portions of the reference half-cell, the measuring half-cell, and the combination assembly therethrough, wherein the seals in combination with the housing, the measuring half-cell and the combination assembly, define an electrolyte compartment for the reference half-cell;
(g) extending the sensing element, porous member, and end cap, through the seal disposed at the distal end of the housing, to enable direct contact with a test fluid, wherein the end cap provides close thermal coupling to the test fluid while also serving as a test fluid ground that is electrically isolated from the electrolyte compartment;
(h) configuring one or more of the housing, measuring half-cell, reference half-cell, and combination assembly, as modular components, wherein the measurement sensor is configured for being fabricated in a plurality of lengths by altering the length of the housing independently of the measuring half-cell, reference half-cell, and combination assembly.
